(19) United States
(12) Patent Application Publication
(10) Pub. No.: US 2007/0067172 A1
(43) Pub. Date: Mar. 22, 2007

(54) Method and apparatus for performing conversational opinion tests using an automated agent

(76) Inventors: Minkyu Lee, Ringoes, NJ (US); James William McGowan, Whitehouse Station, NJ (US)

Correspondence Address: Lucent Technologies Inc.;Docket Administrator, Room 3J-219, 101 Crawfords Corner Road, Holmdel, NJ, 07733-3030, US

(21) Appl. No.: 11/233,309

(22) Filed: Sep. 22, 2005

(51) Int. Cl. G10L 15/18

(52) U.S. Cl. 704/257

(57) ABSTRACT

A method and apparatus for performing a conversational opinion test using a human tester and an automated agent (e.g., a computer program). The human tester and the automated agent advantageously converse by following a pre-defined script. A network simulation box, interposed between the human tester and the automated agent, advantageously controls the conversational channel characteristics such as, for example, background noise, delay and echo. After the conversation is finished, the tester evaluates the conversational quality as defined, for example, in the ITU-T P.800 standard.

### FIELD OF THE INVENTION

The present invention relates generally to the field of quality of service determinations for telecommunications systems, and in particular to a method and apparatus for performing conversational opinion tests for such systems using an automated agent.

### BACKGROUND OF THE INVENTION

Measuring the quality of service (QoS) provided by telecommunications systems is becoming increasingly important as novel communications techniques, such as, for example, voice over Internet Protocol (VoIP), are employed to transmit telephone calls. One means of measuring QoS is with the use of what is known as a conversational opinion test, which evaluates the overall subjective quality of a call involving two parties based on one or both parties listening to the voice quality of the other and determining the ease of holding a two-way conversation during the call.

ITU-T P.800, a standard promulgated by the International Telecommunications Union standards organization and fully familiar to those skilled in the art, specifies test facilities, experimental designs, conversation tasks, and test procedures which may be used to perform such a conversational opinion test. When following the ITU-T P.800 standard, it is important that the conditions simulated in the tests are correctly specified and properly set up, so that the laboratory-based conversation test adequately reproduces the actual service conditions experienced by actual users in a real-world telecommunications environment. More specifically, a pair of (human) testers are placed into an interactive scenario and asked to complete a conversational task. During the simulated conversation, a network simulator artificially introduces the effects of various network impairments such as packet loss (assuming a VoIP environment), background noise, (variable) delays, and echo. Then, one or both of the testers are required to subjectively rate the quality of service of the conversation (or various aspects thereof). Due to the rigorous requirements for performing the test, it tends to be an expensive and time-consuming process.

### SUMMARY OF THE INVENTION

In accordance with the principles of the present invention, a method and apparatus is provided for performing a conversational opinion test using a human tester and an automated agent (e.g., a computer program). The human tester and the automated agent advantageously converse by following a pre-defined script. A network simulation box, interposed between the human tester and the automated agent, advantageously controls the conversational channel characteristics such as, for example, background noise, delay and echo. After the conversation is finished, the tester evaluates the conversational quality as defined, for example, in the ITU-T P.800 standard.

### BRIEF DESCRIPTION OF THE DRAWINGS

FIG. 1 shows an illustrative prior art environment for performing a conversational opinion test using two human testers.

FIG. 2 shows an environment for performing a conversational opinion test using a human tester and an automated agent in accordance with an illustrative embodiment of the present invention.

FIG. 3 shows a flowchart for an illustrative conversational manager, which may, in accordance with one illustrative embodiment of the present invention, be implemented by the automated agent of the illustrative embodiment of the present invention shown in FIG. 2.

### DETAILED DESCRIPTION OF THE ILLUSTRATIVE EMBODIMENTS

FIG. 1 shows an illustrative prior art environment for performing a conversational opinion test using two human testers. The illustrative environment includes human testers 11 and 13, as well as network simulator 12. As described above, in operation of the environment of FIG. 1, the two human testers (i.e., human tester 11 and human tester 13) are asked to complete a conversational task. During the simulated conversation, network simulator 12 artificially introduces the effects of various network impairments such as, for example, packet loss (assuming a VoIP environment), background noise, delays, and echo. Then, one or both of the testers are asked to subjectively rate the quality of service of the conversation (or various aspects thereof). For example, the quality of service may be rated with use of a “mean opinion score” (MOS). (MOS-based rating is fully familiar to those of ordinary skill in the art.)

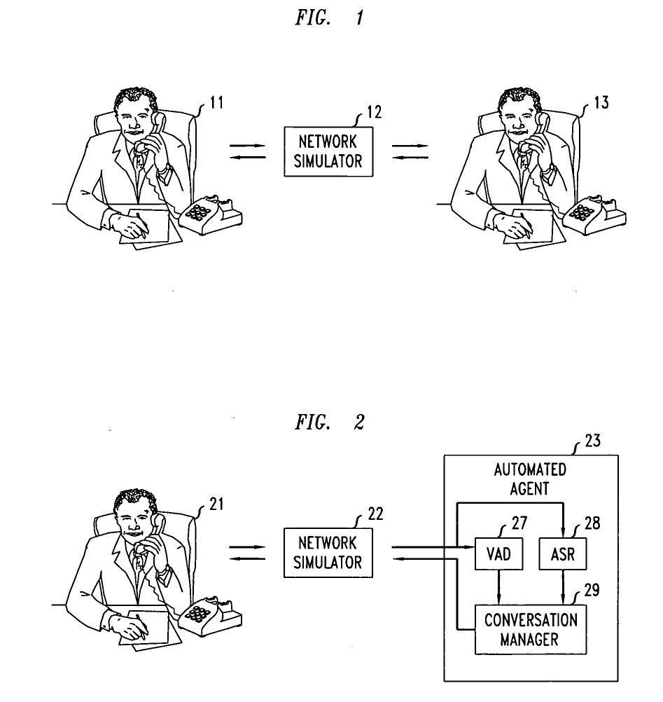

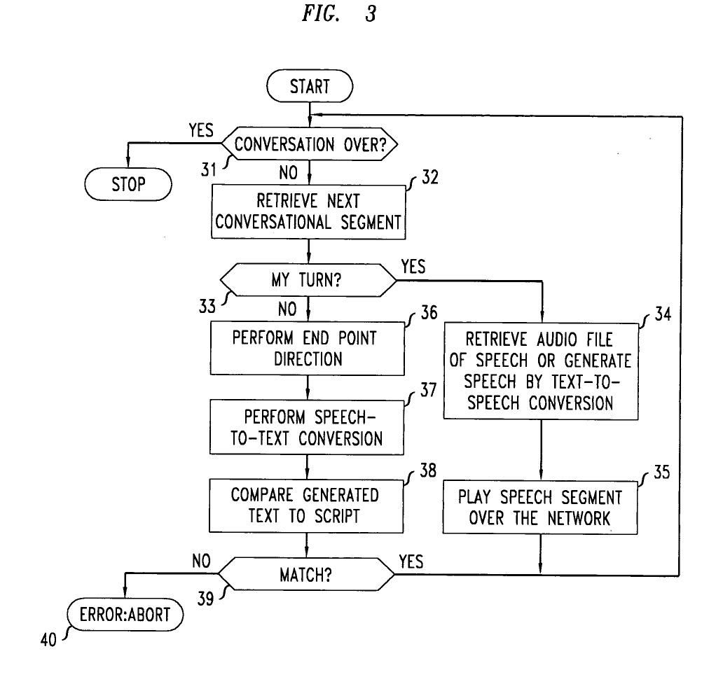

FIG. 2 shows an environment for performing a conversational opinion test using a human tester and an automated agent in accordance with an illustrative embodiment of the present invention. The illustrative environment of FIG. 2 advantageously comprises human tester 21, network simulator 22, and, in accordance with the principles of the present invention, illustrative automated agent 23. Illustrative automated agent 23 advantageously comprises voice activity detector (VAD) 27, automatic speech recognizer (ASR) 28, and conversation manager 29.

In operation of the illustrative environment of FIG. 2, human tester 21 advantageously converses with automated agent 23 by following a pre-defined script. Network simulator 22 advantageously controls various conversational channel characteristics such as, for example, background noise, delay and echo. Note that network simulator 22 may be implemented as software executing on a general or special purpose processor, or, alternatively, may be implemented in hardware or firmware. After the conversation between human tester 21 and automated agent 23 is finished (e.g., after the pre-defined script has been completed), human tester 21 evaluates the conversation quality as defined, for example, in the ITU-T P.800 standard.

More specifically, as described above, automated agent 23 of the illustrative embodiment of the invention shown in FIG. 2 comprises voice activity detector 27, automatic speech recognizer (ASR) 28, which may, for example, comprise a speech-to-text translation system, and conversation manager 29, which advantageously controls the operation of automated agent 23. Note that voice activity detector 27 and automatic speech recognizer 28 may be implemented with use of fully conventional components which will be familiar to those of ordinary skill in the art. Moreover, note that voice activity detector 27 and automatic speech recognizer 28, as well as conversational manager 29, may all be implemented as software executing on a general or special purpose processor. Alternatively, one or more of these components may be implemented in hardware or firmware.

Specifically, in the operation of illustrative automated agent 23 of FIG. 2, the voice activity detector advantageously identifies the end of the human tester's conversational turn, and then the automatic speech recognizer advantageously converts the received speech into text. The conversation manager then advantageously compares the resultant text against the aforementioned pre-defined script.

In accordance with one illustrative embodiment of the invention, if the conversation manager verifies that the conversation is following the given script, the conversation manager then determines a corresponding responsive speech message based on the pre-defined script. This responsive speech message may, in accordance with one illustrative embodiment of the present invention, be determined by retrieving a corresponding response text message from the script and then converting that text message into speech with use of a conventional text-to-speech (TTS) system. In accordance with another, preferred embodiment of the present invention, the conversation manager extracts a pre-recorded (human) speech segment which comprises the corresponding response speech message. In either case, the responsive speech message is then played through the network simulator to the human tester. During the playback, the network simulator advantageously adds noise, delay and/or echo in the speech, based on the desired test conditions.

FIG. 3 shows a flowchart for an illustrative conversational manager, which may, in accordance with one illustrative embodiment of the present invention, be implemented by the automated agent of the illustrative embodiment of the present invention shown in FIG. 2. As shown in the figure, the process comprises a continuous loop for as long as a given conversation ensues.

Specifically, the loop begins at decision block 31 where it is determined if the pre-defined script of the conversation has been completed. If it has, the process terminates, but if it has not, the next conversational segment is retrieved from the script (in block 32). Then, decision block 33 determines whether it is the turn of the automated agent or the turn of the human tester. If it is the turn of the automated agent, flow proceeds to block 34 where, depending on the particular embodiment of the invention, either the appropriate audio file containing the speech segment (which corresponds to the given text segment of the pre-defined script) is retrieved, or an audio speech segment is generated from the appropriate text segment of the pre-defined script (with use of, for example, a text-to-speech conversion system). Then, in block 35, the given (i.e., either retrieved or generated) audio speech segment is played over the network, and finally, flow returns to decision block 31 to continue the looping process.

If, on the other hand, it is determined by decision block 33 that it is the turn of the human tester, flow proceeds to block 36 to perform end point detection—i.e., to identify with, for example, use of voice activity detector 27, when the speech segment received from the human tester has been completed. When it has been completed, block 37 performs speech-to-text conversion on the received speech segment, with use of, for example, automatic speech recognizer 28, to generate text representing the given speech segment. Then, block 38 compares the generated text with the expected text from the pre-defined script and decision block 39 determines whether or not there is a match. If there is not a match, then in accordance with the illustrative embodiment of the present invention shown in FIG. 3, the process aborts with an error (terminating block 40). If, on the other hand, there is a match, flow again returns to decision block 31 to continue the looping process. Note that in accordance with other illustrative embodiments of the present invention, matching failures between the text generated from the human tester's speech and the anticipated text from the pre-defined script may be simply ignored.

In accordance with various illustrative embodiments of the present invention, pre-defined conversational scripts can be obtained in a number of ways, many of which will be obvious to those skilled in the art. Since it is highly advantageous that the conversation be as realistic as possible, one possible way in accordance with one illustrative embodiment of the invention is to pre-record actual phone conversations between people. After such a recording has been made, the conversation can be either transcribed by a human listener or automatically converted to text using conventional speech-to-text conversion tools such as an automatic speech recognition (ASR) system, thereby producing a pre-defined script. Note that by using such a method, actual audio speech segments for the automated agent's part in the conversation of the script may be advantageously obtained. Note that there are numerous available databases, fully familiar to those skilled in the art, which contain many conversational recordings which may be so used.

### ADDENDUM TO THE DETAILED DESCRIPTION

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

We claim:

1. A method for performing a conversational opinion test with use of an automated agent, the conversational opinion test for generating a quality evaluation of a conversation by a human tester, the conversation comprising a sequence of conversational speech segments and responsive speech segments, the method comprising the steps of:
receiving one or more conversational speech segments spoken by the human tester, the received conversational speech segments having been passed through a network simulator;
automatically producing, with use of said automated agent, one or more responsive speech segments, the one or more responsive speech segments responsive to corresponding ones of said one or more received conversational speech segments and determined based on a pre-defined script; and
playing said one or more automatically produced responsive speech segments through said network simulator back to said human tester.

2. The method of claim 1 wherein said step of automatically producing said one or more responsive speech segments comprises selecting one or more corresponding pre-recorded audio speech segments from a set of pre-recorded audio speech segments based on said pre-defined script.

3. The method of claim 1 wherein said step of automatically producing said one or more responsive speech segments comprises generating one or more corresponding audio speech segments based on one or more text segments comprised within said pre-defined script.

4. The method of claim 3 wherein said one or more audio speech segments are generated with use of a text-to-speech conversion technique.

5. The method of claim 1 wherein the network simulator operates in accordance with, and the quality evaluation of the conversation by the human tester is performed in accordance with, the ITU-T P.800 standard.

6. The method of claim 1 wherein the network simulator introduces network effects including noise, delay and echo into the conversation.

7. The method of claim 1 wherein said step of receiving the one or more conversational speech segments spoken by the human tester comprises detecting end points of the conversational speech segments with use of a voice activity detector.

8. The method of claim 1 wherein said step of receiving the one or more conversational speech segments spoken by the human tester comprises performing automatic speech recognition on said received conversational speech segments.

9. The method of claim 8 wherein said automatic speech recognition is performed with use of a speech-to-text conversion technique to generate one or more text segments corresponding to said one or more received conversational speech segments.

10. The method of claim 9 further comprising the step of comparing the one or more generated text segments with corresponding portions of the pre-defined script, and aborting the conversation when one of said generated text segments does not match the corresponding portion of the pre-defined script.

11. An automated agent for performing a conversational opinion test with a human tester, the conversational opinion test for generating a quality evaluation of a conversation by the human tester, the conversation comprising a sequence of conversational speech segments and responsive speech segments, the automated agent comprising:
means for receiving one or more conversational speech segments spoken by the human tester, the received conversational speech segments having been passed through a network simulator;
means for automatically producing one or more responsive speech segments, the one or more responsive speech segments responsive to corresponding ones of said one or more received conversational speech segments and determined based on a pre-defined script; and
means for playing said one or more automatically produced responsive speech segments through said network simulator back to said human tester.

12. The automated agent of claim 11 wherein said means for automatically producing said one or more responsive speech segments comprises means for selecting one or more corresponding pre-recorded audio speech segments from a set of pre-recorded audio speech segments based on said pre-defined script.

13. The automated agent of claim 11 wherein said means for automatically producing said one or more responsive speech segments comprises means for generating one or more corresponding audio speech segments based on one or more text segments comprised within said pre-defined script.

14. The automated agent of claim 13 wherein said one or more audio speech segments are generated with use of a text-to-speech conversion technique.

15. The automated agent of claim 11 wherein the network simulator operates in accordance with, and the quality evaluation of the conversation by the human tester is performed in accordance with, the ITU-T P.800 standard.

16. The automated agent of claim 11 wherein the network simulator introduces network effects including noise, delay and echo into the conversation.

17. The automated agent of claim 11 wherein said means for receiving the one or more conversational speech segments spoken by the human tester comprises a voice activity detector for detecting end points of the conversational speech segments.

18. The automated agent of claim 11 wherein said means for receiving the one or more conversational speech segments spoken by the human tester comprises performing automatic speech recognition on said received conversational speech segments.

19. The automated agent of claim 18 wherein said automatic speech recognition is performed with use of a speech-to-text converter which generates one or more text segments corresponding to said one or more received conversational speech segments.

20. The automated agent of claim 19 further comprising the means for comparing the one or more generated text segments with corresponding portions of the pre-defined script, whereby the conversation is aborted when one of said generated text segments does not match the corresponding portion of the pre-defined script.
